(19) United States
(12) Patent Application Publication
(10) Pub. No.: US 2023/0359999 A1
(43) Pub. Date: Nov. 9, 2023

(54) SYSTEM FOR COLLABORATIVE USER FACING PROJECT MANAGEMENT AND IMPLEMENTATION METHOD THEREOF

(71) Applicant: ROCKETLANE CORP., Wilmington, DE (US)

(72) Inventors: Deepak BALU, Walnut, CA (US); Srikrishnan GANESAN, Walnut, CA (US); Vignesh GIRISHANKAR, Walnut, CA (US)

(21) Appl. No.: 18/312,214

(22) Filed: May 4, 2023

Related U.S. Application Data
(60) Provisional application No. 63/338,317, filed on May 4, 2022.

(51) Int. Cl. G06Q 10/10

(52) U.S. Cl. CPC G06Q 10/103

(57) ABSTRACT

A method and a cloud-based collaborative system for user-facing project management is disclosed, wherein the implementation method facilitates vendors, one or more users, and one or more third-party entities to communicate and collaborate for tracking and managing projects and implementation. Specifically the system allows each stakeholder to connect their tools for seamless communication, collaboration, and productivity.

### FIELD OF INVENTION

A system and method are disclosed for a cloud based user facing project management with a platform for managing project delivery and implementations. Disclosed is a collaborative system for user facing project management enabling seamless project delivery and implementation. Particularly the invention relates to a collaborative user facing project management system that enables seamless communication between multiple parties and integrates one or more users, vendors and any third parties. Additionally the platform facilitates a method for collaboration, and productivity between users, vendors and any third parties by connecting their internal tools to the user facing project management platform for seamless communication, collaboration and productivity.

### BACKGROUND OF INVENTION

Project management and onboarding/implementation are interchangeable terms in the context of this invention where a set of activities are performed by one or more groups of people for a business/customer. Users include customers of businesses, candidates applying for a role with a company, employees being on boarded by their company etc. Process of onboarding, integration of tools and project implementation generally falls under project management.

Cloud project management platforms provide various systems for customer onboarding and implementation and project management for different types of applications and services.

U.S. Pat. No. 8,880,436 discloses systems and methods for an automation methodology used in a web based implementation portal. The invention disclosed web-based implementation portal, project implementation according to various embodiments of the present invention, and is no longer an abstract list of service pledges by banks. Companies can visualize at each stage exactly how a solution will be implemented for them. In some embodiments, through embedded workflow steps and pre-defined templates, the portal can standardize and automate the customer onboarding process. The process can be standardized and automated from the time the customer confirms subscription to specific commercial solutions to the time when these commercial products are implemented and used by the customer.

US20200274835 discloses methods, systems, and apparatus for programmatically managing integration of a third party resource in a group-based communication system are provided herein.

However, none of the prior art discloses a method and system that provide a collaborative platform for seamless communication exchange between users or customers, vendors and third parties. Therefore there is a need in the prior art to provide a platform which not only on-boards customers but integrates the communication and service tools of customers, vendors, and third party entities allowing these multiple parties to connect their tools to the project management platform for seamless communication, collaboration and productivity for the project implementations thereof.

### OBJECTS OF THE INVENTION

The invention may be further defined with reference to the various objects it seeks to attain.

It is a principal object of the present invention to provide a system for collaborative user-facing project management and implementation

It is another object of the present invention to provide a single cloud based platform which unifies one or more users, one or more third party entities and their vendors in a single platform for project management and implementation.

It is yet another object of the present invention to provide a system and method for organization level collaboration, wherein the system enables management of business services, project management, and governance for users along with interfacing vendors or service providers and third party entities.

It is another object of the present invention to provide a system for collaborative user-facing project management that seamlessly brings together various point solutions for business services management and governance with intent of providing a single window that enables access to the underlying data for connected user-vendor-third party operations.

It is yet another object of the present invention to provide a collaborative user facing project management system and method that enables managing user-facing projects, where stakeholders have clear accountability on their activities, visibility on the status of their activities and collaborate together over email and chat to complete the projects.

It is another object of the present invention to provide a collaborative user facing project management system and method wherein the system is configured to integrate stakeholder's internal tools, like communication and service tools and the like to integrate the project management software with their tools.

It is another aspect of the invention, to provide a collaborative user facing project management system and method, for simplifying the adoption and implementation of not only workflow and project management, but also promotes stakeholder collaboration.

In another aspect of the invention, the system and method focuses on the stakeholders working in the user's environment in terms of addressing their needs for seamless collaboration and business service delivery.

### SUMMARY

It is a principal aspect of the present invention to provide a system for collaborative user facing project management, comprising:
a service provider interface with a user facing project management platform;
a network;
one or more servers;
one or more user interfaces comprising vendor and associated parties;
wherein the user facing project management server comprises a communication collaboration module, processor, database or memory, a communication repository, data presentation module, data retrieving module, data notification module and computer readable instructions which when executed by the processor:
on boards users comprising vendors and associated third party entities, provides a communicable linkage by the communication collaboration module adapted to map information flow between service provider, vendors, and third parties associated with vendors, integrates the communication tools and work flow management tools of the users with the platform,
the communication repository is configured to dynamically update and store real-time data from one or more of the communication tools and the work flow management tools, integrated to the platform, database to store all the data the data retrieving module configured to retrieve relevant data from the memory and the communication repository based on the user input, and
the data presentation module adapted to provide conditional access to data mapped and identified by the communication collaboration module over the platform and display on the dashboard for exchange between vendor, and third parties that are integrated real-time to the platform, to access, manage and implement projects, project related communication and work flow management directly on the single user facing project management platform.

It is another aspect of the present invention to provide a system for collaborative user facing project management, wherein the communication tools are selected from internal communication tools inbuilt in the server of service provider platform or external communication tools.

It is another aspect of the present invention to provide a system for collaborative user facing project management, wherein, wherein the work flow management tools are selected from Jira, Slack, Zendesk, and the like.

It is another aspect of the present invention to provide a system for collaborative user facing project management, wherein the communication tools comprises of MS teams, Google meet, electronic messaging accessible on any computer implementable device, comprising email, gmail, electronic text messaging and the like.

It is yet another aspect of the present invention to provide a method of implementation of a collaborative user facing project management system, comprising steps:
a. subscribing by a first user to a user facing service provider platform and accession by authentication;
b. connecting to the server over the network after authentication;
c. on-boarding a second user or customer onto the service provider platform;
d. initiation of a session on the interface for synchronous communication initially between the first user at the interface with the customer for customer onboarding;
e. initiation of one or more projects between the first user, customer, and vendor over the platform comprising associating one or more customer projects on the platform;
f. Onboarding of the customer, vendor and third party entities by providing them access to the platform;
g. presentation by a presentation module of the dashboard view of one or more aspects of the project wherein the first user, customers, vendor and associated parties comprising all users are in network communication on the platform and the communication is selectively enabled by the first user between the customer and vendor depending on level of access provided by the user;
h. collaboration by a collaborating module of the user, customer, vendor, and third party entities on the platform;
i. initiation of the session on the shared space of the platform for real time interaction;
j. mapping of the information flow between the first user, customer, vendor, and third party entities, and integration of the communication tools of the user, customer, vendor and associated entities to the platform by the collaboration module over the network;
k. storing real-time and historic data of the interactive communication in the session related to the projects, related data and communication data of the user, customer, vendors and associated parties in the communication repository;
l. storing of the shared and other project related data of the user, customer, vendors and third parties post session in the database;
m. retrieving of the relevant data by the data retrieving module in the server as selected by the user customer and vendor and associated parties from the database, and
n. wherein the platform is configured to collaborate and share centralized communication shared between the parties collaborating on the platform, collaborate one or more teams workflow management and integrate the data on the user facing project management platform from external and internal communication and workflow management tools.

It is another aspect of the present invention to provide a method of implementation or execution of a collaborative user facing project management system, wherein data stored in the memory comprises project configuration and progress data, and communication repository comprises of communication exchange data between vendors customers and third parties from internal and external communication tools.

It is another aspect of the present invention to provide a method of implementation or execution of a collaborative user facing project management system, wherein project progress data is selected from, but not limited to status, stage of progress, meeting of timelines, and the like.

It is another aspect of the present invention to provide a method of implementation or execution of a collaborative user facing project management system, wherein the platform comprises a share space in the server for real-time data sharing between collaborating parties.

It is another aspect of the present invention to provide a method of implementation or execution of a collaborative user facing project management system, wherein the user interface comprises computer implementable device comprising personal computer, laptop, hand held computer, personal digital device, electronic tablet, cellular phone, any smart of intelligent electronic device and the like.

It is another aspect of the present invention to provide a method of implementation or execution of a collaborative user facing project management system, wherein the project view can be stored as a template and replicated for future use for other projects.

It is another aspect of the present invention to provide a method of implementation or execution of a collaborative user facing project management system, wherein data module is configured to update the database and extract the data based on the user selection of data preferences on the platform.

It is another aspect of the present invention to provide a method of implementation or execution of a collaborative user facing project management system, wherein the dashboard view of the platform is configured to provide a consolidated view of all the ongoing projects in a single window simultaneously.

It is another aspect of the present invention to provide a method of implementation or execution of a collaborative user facing project management system, wherein the dashboard of the platform is configured to be accessed on any computer implementable device.

It is another aspect of the present invention to provide a method of implementation or execution of a collaborative user facing project management system, wherein the data is exchanged between the vendor, and any third party associated to the vendor on the webpage or the portal by dynamic transfer using the dynamic communication tools.

It is another aspect of the present invention to provide a method of implementation or execution of a collaborative user facing project management system, wherein communication tools are inbuilt tools in the server or external communication tools selected from one or more of Jira, Slack, Zendesk, MS teams, Google meet and the like that are integrated into the platform by the communication collaboration tool.

### BRIEF DESCRIPTION OF DRAWINGS

FIG. 1 illustrates a collaborative user facing project management system and method thereof according to various embodiments of the present invention.

FIG. 2 illustrates Customer C1's (Example 1) view of the User facing project management platform according to embodiments of the present invention.

FIG. 3 illustrates Vendor V1's (Example 1) view of the User facing project management platform according to embodiments of the present invention.

FIG. 4 illustrates Third party entity T1 associated with the Vendor V1 (Example 1) view of the User facing project management platform according to embodiments of the present invention.

FIG. 5 depicts a screenshot of the workflow management tool (eg. Slack) as captured on the Customer C1's view who is collaborated with the company X and depicting status of an account set up according to exemplary embodiment of the present invention.

FIG. 6 depicts a screenshot of the workflow management tool (eg. Slack) as captured on the Vendor V1's view who is collaborated with the company X and depicting status of an account set up according to exemplary embodiment of the present invention.

FIG. 7 depicts a screenshot of the workflow management tool (eg. Slack) as captured on the Third party T1's view collaborated with the company X and depicting status of an account set up according to exemplary embodiment of the present invention.

### DETAILED DESCRIPTION OF THE INVENTION

Specific examples of system components and arrangements are detailed below to define the present disclosure. These are, of course, merely examples and are not intended to be limiting. In addition, the present disclosure may repeat reference numerals and/or letters in the various examples. This repetition is for the purpose of simplicity and clarity and does not in itself connote a correlation between the various embodiments and/or configurations discussed.

As discussed in detail in the background current customer facing project management systems have drawbacks comprising: poor visibility; None of the currently available tools are equipped to provide a unified interface or a shared space which can give multiple users who are either customers, vendors and vendor associated third parties a unified view of all the stages and all the aspects of ongoing collaborative projects, with quick links to rely for effective communication.

Existing collaborative platforms and associated tools did not address the collaboration of communication tools and workflow management tools on a single unified interface At times due to the vastness of the data relating to plethora of projects, and too many tools which were needed to communicate or shared different categories of communication, increased complexity of the project management leading to lag in meeting deadlines and disorganized or time consuming processes to follow up. Further tedious to pull out historical data to meet any customer requirement.

Multiple tools and complexity: Currently available onboarding tools cannot integrate both workflow and communication on one system. So, workflow control is independent of communication sharing and control. If two parties that have collaborated on a project need to communicate, then workflow management is on one tool and communication on another tool, making it complex.

No collaboration and subpar customer experience; Tools currently available, are unable to give customers a unified experience at one click, the project management system of the present invention as disclosed in various embodiments of the present invention. The present invention alleviates these drawbacks in the way discussed below.

The present invention, relates to the field of collaborative computing, and more particularly, to a system and method for providing collaborative user facing project management system, which is configured to provide a shared space whereby multiple users can access this shared space. The shared space of the platform is accessible to interact real time. The platform is configured to provide exceptional customer onboarding experience. The users are first user which is a company or an individual or an entity which is involved in project management with one or more customers and vendors and third parties.

The first user onboards the second user a customer. The first user further collaborates with vendors related to a particular project, third party entities including users who need selective access to the platform of the system. This is to perform tasks and interacts such as collaborative project management that includes both workflow management and communication management on a single unified collaborative interface, of the present invention.

The collaborative activities are included but not limited to
a. access to a project on the collaborative user facing platform to the customers who are onboarded, their clients, vendors and the third parties.

Access and status is real time or dynamic access or acess historical data and communication sent and received as notifications on logging in post a session.

Ability to individualize access i.e the access is under the control of the project management team at their user interface of the first user associated with the customer for project implementation.

Access could be sharing of all the various types of data related to that project.

Only users collaborated on a particular project have access to the platform strictly for the said project.

Access comprise a shared space is defined as a virtual reference point whereas multiple users can interact in real-time upon shared objects.

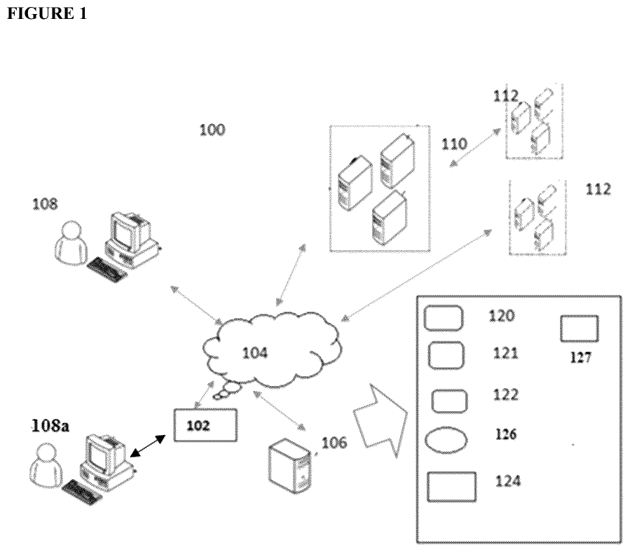

In one embodiment of the present invention is disclosed a system 100 for collaborative user facing project management. The system (100) as illustrated in FIG. 1, comprises a first user interface, wherein the first user 108a has subscribed to the user facing project management platform of a service provider interface 102 configured to display a user facing project management platform when initiated. The user facing project management platform is the common connecting point between the customers and vendors and associated third parties. It is of particular relevance that this is a collaborative platform which provides a unified space for interaction of the first user with second user/client/customer with stakeholders/vendors and vendor associated third parties simultaneously.

The user facing project management platform is enabled by the service provider, at a first computer/device (102). It is configured to be accessed on any computer implementable device, for eg. A desktop or a mobile app (Application Program Interface). The service provider platform 102 is in network 104 communication with other users. Since, the invention particularly relates to User onboarding, with emphasis on user facing project management for highest user onboarding experience, the first user of the platform is a company or individual who is subscribed to the user facing project management platform 102 for project implementation. The first user in exemplary embodiment is either a company, enterprise or an individual who collaborates with the customers, vendors, third parties or any other stake holders. The first user onboards a second user is a customer, and one or more Vendors 110, the platform 102 configured to be in network communication with third party entities 112 either directly or through the vendors, as illustrated in FIG. 1. Users 108, 108a, (Company is 108a subscribed to user facing project implementation platform) collaborate on one or more user interfaces 108, 108a comprising customer who is onboarded 108, vendor 110 and associated parties 112. A single project is accessed by all the users as mentioned here in the shared spaced, comprising user facing project management platform interface. At the platform all the associated or collaborated users are in synchronous communication real-time with the users i.e. the customers, vendors, and third parties. The first user has the choice of customized and selective access provision, wherein access to different aspects of the platform 102 to the users i.e customers, vendors and third parties is customizable and configurable at the service provider end. The platform is configured to provide in an interactive session first user controlled access to data, i.e. the first user can define data that will be shared with any of the users on the other end. First user is the generator where the session is initiated, he can share or internalized date that should be visible on the other user interfaces of customer and vendors. Customers and Vendors see only the shared data.

Here the service provider owns the user facing project management platform 102 to which the first user is subscribed to, for availing user onboarding and collaborative communication and project management implementation.

According to one exemplary embodiment of the invention, a system comprises one or more users. The first user is a company or enterprise or an individual 108a who has subscribed to the services of the user facing project management platform at a service provider interface 102, collaborating on the platform with second user who is a customer who is on boarded onto the platform for project management. The second customer 108 is in network collaboration for project management by the first user with third user who is one or more service vendors 122 and their associated third party entities 112. The first user can be treated as one at whose end the project implementation is controlled. Although, the first user can provide access to the other users for changing the data aspects, which are changed and saved in the database. The project implementer is first user who has the control of the project management and who decides on the 102 for selective sharing or complete sharing. The users 108, 108a 110 and also third parties 112 associated with the vendors can access the platform 100 from the computer, Laptop, PDA, or any other computational device. The said communication network 104 can be selected from the internet, intranet, and any other communication networks. In a preferred embodiment, the communication network 124 is internet.

The platform 100 comprises of a processor 121, data presentation module 126, database 122, collaboration scenarios module 120, a communication repository 124, data retrieving module 127, and data notification module 128. This presentation module 126 provides access to all the point solutions for management business services, governance, information sharing across various stakeholders and collaboration.

The network 104 of the present invention includes but not limited to local area network point to point communication, wide area network, global internet and combinations thereof. The system comprises one or more servers 106. The user facing project management server 106 comprises, a processor 121, database or memory 122, a communication collaboration module 120, a communication repository 124, data presentation module 126, data retrieving module 127, data notification module 128 and computer readable instructions which when executed by the processor 121: on boards users comprising vendors and associated third party entities.

The collaboration module is configured such that it collaborates all the user on a single session. A session is a single time bound interaction between the users 108, 108a, 112, 110 at the interface 102 over a network. Each session is initiated by the first user 108, and on sharing for example interactive tools like magic links provides access to the other user. The interaction is simple and in the shared virtual space by means of multiple options relating to the project that is simultaneously displayed by the display module over the interactive session. It can be explained that the collaboration module is configured to receive electronic communication input originating from the one or more client computer devices or user interfaces 102, 108a, 108, 110 and 112 to store the electronic communications as project activity data in the database 122, and to arrange the received electronic communication input into a centralized location in the server 106 (e.g., an activity feed of the particular project) for enabling centralized and efficient project-related collaboration. The server also hosts the communication repository 124, data presentation module 126 and data retrieving module 127. The communication collaboration module 120 is adapted to map information flow between service provider, customers, vendors, and third parties associated with vendors, integrates the communication tools and work flow management tools of the users with the platform 102.

In one preferred embodiment the platform 100 provides applications for project management, workflow management, communication management between the customers (108, 108a) logged in to the service provider interface 102 and connected to vendors 110 and stake holders over a network communication. Once the customer is onboarded onto the platform which starts with subscription to the services of the user facing project management platform 102, the User gets access to the platform. It is interactive and a project wherawn initiated is keyed in to the platform 102 and access is provided to the customer and vendors 110 who are collaborating on the project. The object of the present invention is to lessen the information flow and make is simpler, quicker, accessible and understandable by avoiding multiple links, shares, data, progress and the like.

The communication collaboration module 120 is evoked by the processor in response to computer implementable instructions, which are either a software programme or algorithms that when executed in the processor perform the method of the present invention for customer onboarding and collaboration over the user facing project management platform 102. The system is so configured that the communication stream of events is initiated at the user facing project management platform 102 of the system 100, by the first user 108a. To enable the objective of superior customer onboarding and collaboration with vendors and third parties. The interactive session is initiated at the first user interface 108 of the platform 102 by authentication. Once the first user initiates and on boards a second user who is a client or a customer who is defined as having a working relationship with the first user over one or more project implementations. This second user is a customer who is onboarded by the interactive session on the platform. The platform is configured to communicate the real time shared space. The access of the customer to the shared space is authorized by the first user, by sending a web based link for access based on customer authentication.

The communication repository 124 is configured to dynamically update and store real-time data from one or more of the communication tools and the work flow management tools, integrated to the platform. The inventiveness of the present invention lies in the below

It can real time integrate or collaborate all the communications both external and internal of the multiple users over the platform.
a. The internal communication between users of the platform.
b. external communication between the various parties, ie. User 1 comprising a company which onboards the user for a project implementation. The present invention and the platform are particularly and specifically configured such that the collaboration module in the server can collaborate and integrate external communication using tools like email, text message and the like on external tools like teams, outlook, gmail and others. None of the existing collaborative platform provide a unified solution and one point communication both external and internal between customer, user, vendor and third parties in a single shared space of the user facing project management platform.

This communication from all the various tools both internal and external are saved in the communication repository. The repository in the server 106 is configured to save data real-time. Repository saves data shared across the platform by various means, figures, text, conversations, chat, which are enabled by communication tools like gmail, outlook, chat, voice call and the like. The communication repository 124 is a data repository which is any destination designated for data storage. For example, data storage could include semiconductor storage read-write random-access memory (RAM) (e.g., dynamic-RAM or DRAM), hard drives, optical disk drives, or other non-volatile disk storage. Data may also be stored on non-volatile storage devices (e.g., secondary storage) including flash drives and standalone RAM disks. Data may be a particular group or groups of one or more databases. Data may be partitioned within the data repository based on, for example, security of data. The communication repository hosts the user profile which is of the first user that is a company that has subscribed to the services of the service provider platform 102 over a network. Data can be retrieved both real time and historic data, real time as and when it is getting saved in the repository and historic data related to the project in the data base.

The first user interface hosting the user facing project management platform 102 may communicate access the data repositories 124, wherein the processor is configured to take a command at the user interface and process the request by executing computer implementable instructions and provide access one or more of second user data either real time or historically who could be a customer, vendor and third party entities over the network 120.

Database or memory 122 on the other hand is configured to share all the data, spread sheets, presentations, project progress details, status, status in terms of milestones, quality and user feedback, ARR and the like. The data that is shared between relevant parties only who are collaborating on a selected task.

### EXAMPLE 1

For eg; project status from the an implementation team at the first user end i.e for eg. a company, is shared selectively on the shared space on the interface 102 with only the selective team at the vendor or third party end. The control and access of this task is at the first user end. It is totally customizable.

For eg. a company X subscribes the project facing user management platform R, and onboards a second user i.e. User 1 who is Customer 1 represented as C1. Now X the minute it onboards a customer 1, kicks off the project and creates a template relevant to the first Project. The present invention provides the convenience for Company X to onboard Customer C1 and Vendor V1 who collaborates with X and customer C1 to implement the project.

Further, a user 3, i.e. third party entities T1 whose services are used by the Vendor V1 to implement the project of company X for the User 1 or Customer 1 is also provided access in the same interface to watch real-time, the status of the ongoing project.

All the parties that collaborated on the platform have access which is controlled by the company X at 102 or the user facing project management platform. X can choose what is shared amongst V1, C1 and T1. X can also decide and provide a separate url for C1 for an individual project, i.e. a customized window for a particular customer. External communication between C1, V1 and T1 can be integrated. For eg. outlook chat, gmail, text messaging between the three parties can be integrated on the platform and visualized real-time.

PROJECT A with more than one customers and vendors.

### Stages of Project

a. Pre-kickoff
b Discovery and kickoff
c. implementation
d. Training and Go live

### Progress

a. Discovery and kickoff
b. Solution and Planning.
c. Integrations
d. timeline view
f. Team performance on a project.
e. Dependencies

### EXAMPLE 2

### Work Flow Management

Project status from an implementation team at the first user end i.e for eg. a company C1, is shared selectively on the shared space on the interface i.e. at the user facing project management platform R represented by 102 in FIG. 1 with only the selective team at the vendor or third party end T1. The control and access of this task is at the first user end. It is totally customizable.

For eg. a company X subscribes the project facing user management platform, and onboards a second user i.e. User 1 who is Customer 1 or C1. Now X the minute it onboards a customer 1, kicks off the project and creates a template relevant to the first Project. The present invention provides the convenience for Company X to onboard Customer C1 and Vendor V1 who collaborates with X and customer 1 to implement the project.

Further, a user 3, i.e. third party entities T1 whose services are used by the Vendor V1 to implement the project of company X for the User 1 or Customer 1 is also provided access in the same interface to watch real-time, the status of the ongoing project.

All the parties that collaborated on the platform have access which is controlled by the company X at 102 or the user facing project management platform.

X will raise or issue a ticket for completion of a particular project step in the workflow management to a particular sub team Y1 of a vendors team V1, Y1 will only implement the particular task which is a single step and can be provided access to the platform to only provide work flow management status real-time. Y1 will not have access to any other communication but only the work flow related communication. Y1 will also have provision to share its external work flow management tools like Zira and Slack communication over the platform.

### EXAMPLE 3

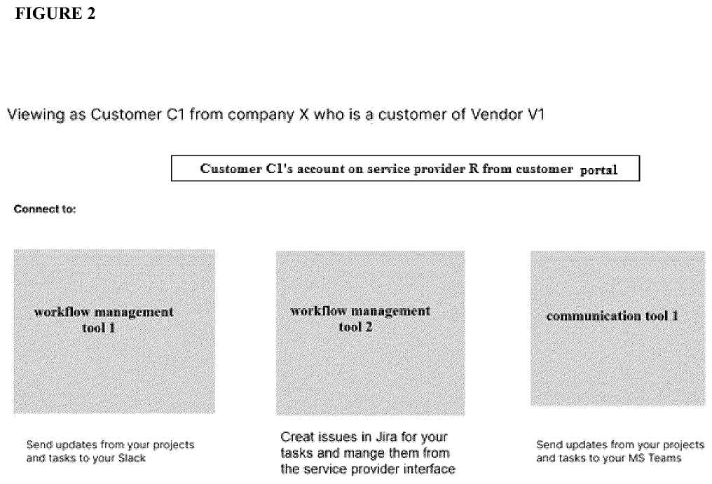

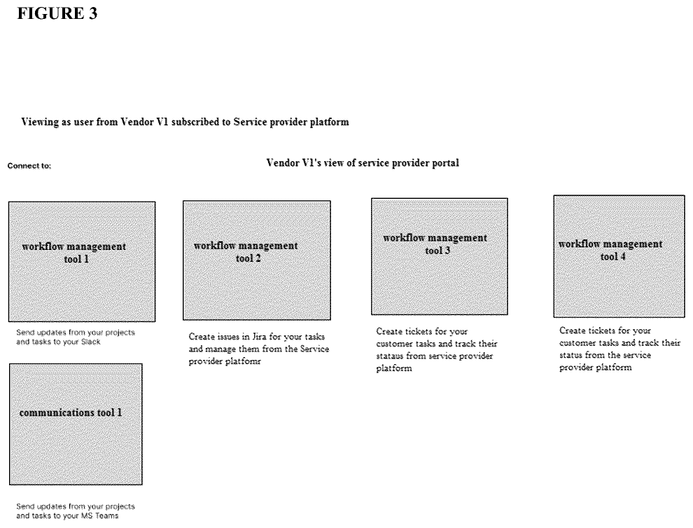

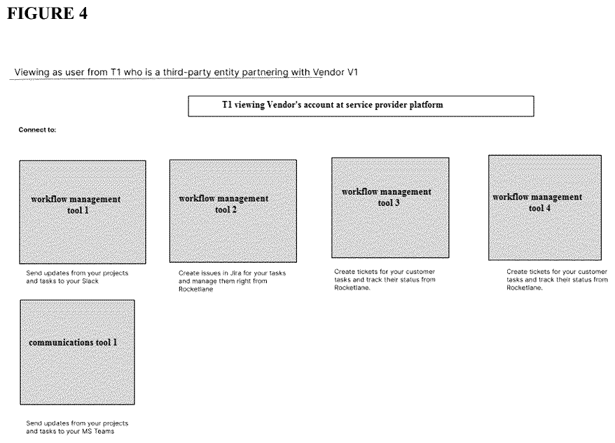

As illustrated in FIG. 2 customer C1 is provided selective access by the company X of the user facing project management platform R. X has provided workflow management tools only access to C1. In FIG. 2, the customer is onboarded and has access to only workflow management tools 1 (for eg. Slack), workflow management tool 2 (Era) and a communication tool (for eg. MS teams) In relation to the same project FIG. 3 illustrates the vendor view of the same user facing project management platform where X has provided the Vendor V1, access to both communication tools and workflow management tools. Here V1 is the vendor working on a particular project collaborating with X over the platform R, and both are responsible for a customer C1 project execution. In FIG. 2 is indicated that X and V1 are integrated via their communication tools for eg. MS teams, i.e. both of them when they update a communication on MS teams it is automatically reflected at both X and V1's interface of the platform. This is unique to the present invention. X and V1 are also collaborating on project implementation using more than one workflow management tools, for eg. Tool 1 represents slack, Tool 2 represents Jira, Tool 3 represents a ticketing tool, for eg. Freshdesk, Tool 4 represents a ticketing tool for eg. Zendesk. So, X and V1 are collaborated on R and have the same interface to share, update and implement projects. in the same interface the communication tool represents for eg. MS teams, all communications between the company and vendor is pushed to the interface. FIG. 4 is a Third party T1 associated to the Vendor V1. X also provides T1 access to the platform to collaborate. Since V1 and T1 are both collaborating to implement the project, T1 also is provided access to both workflow management tools (For eg. Slack, Jira, Fresh desk, Zendesk, MS teams). It is pertinent to understand that X has complete control of the project. Once the customer is onboarded as represented here, C1's communication tools, V1's communication tools and T1's communication tools are integrated, ie any communication related to the said project is reflected realtime between the parties that are provided access by X to the platform R for the said project.

So, X, C1, V1 and T1's slack, Jira are integrated.

X, V1 and T1 are further integrated on Freshdesk and Zendesk. C1 is not provided access as X, V1 and T1 are integrated for project implementation and C1 is the final customer. X, V1 and T1 can create tickets over the platform for workflow management and manage end to end completely on the interface. FIG. 2, 3, 4 represent a single exemplary embodiment, the user facing project management platform of the present invention can integrated more than one tools of both communication and workflow management.

### EXAMPLE 4

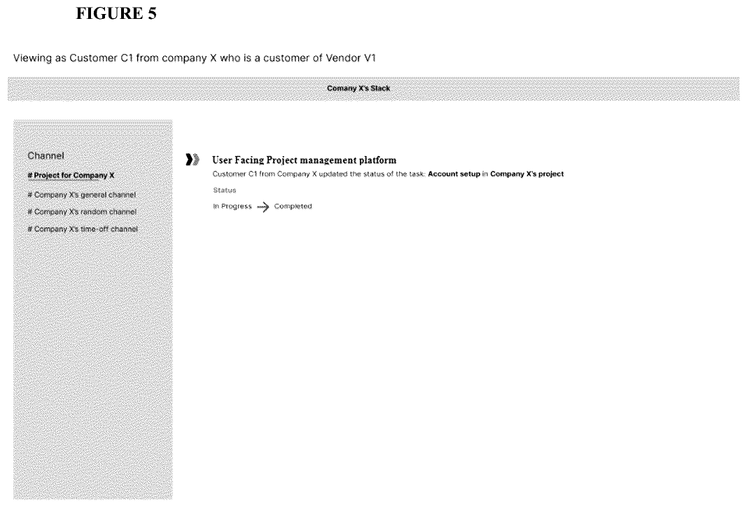

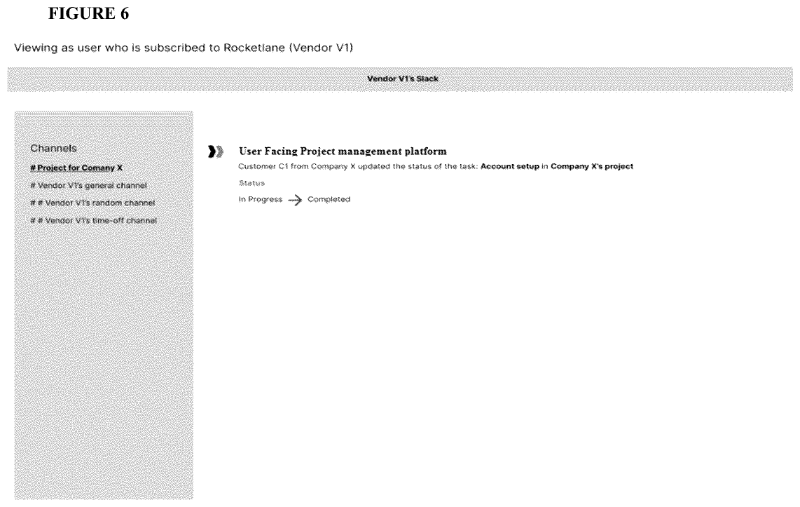

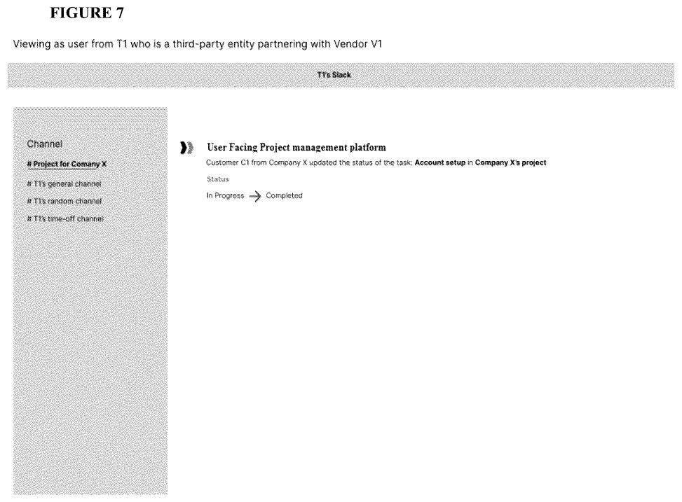

Example 4, represents workflow management and communication updation realtime on the platform. It illustrates integration of workflow over the user facing project management platform according to embodiments of the present invention. Example 4 represents the integration over a workflow management tool for the customer C1, Vendor V1 and Third party T1 over the platform. A company X for a particular project is collaborating with vendor V1, Third party T1 associated with V1 who is also collaborating with X for the project implementation. In FIGS. 2, 3, 4 represents the communication window for a selected project X. Here, the workflow and status is updated on slack. FIG. 5 represents successful onboarding, since all the stakeholders are collaborating, they are notified real time of the status. In slack C1 updated status to be completed for a first task account setup for a project X. As, V1 and X and T1 are also collaborated with C1 for the project the same status is reflected on slack for all the three. FIG. 6 depicts V1 slack indicating the status update, FIG. 7 indicates slack updation for T1 or third party associated with Vendor.

### EXAMPLE 5

PROJECT A with more than one customers and vendors.

### Stages of Project

a. Pre-kickoff
b Discovery and kickoff
c. implementation
d. Training and Go live

### Progress

a. Discovery and kickoff
b. Solution and Planning.
c. Integrations
d. timeline view
f. Team performance on a project.
e. Dependencies

Another embodiment of the present invention discloses a method 200 of implementation of a collaborative user facing project management system 100, comprising steps:
a. subscribing by a first user 108a to a user facing service provider platform 102 and accession by authentication;
b. connecting to the server over the network after authentication;
c. on-boarding a second user or customer onto the service provider platform;
d. initiation of a session on the interface for synchronous communication initially between the first user at the interface with the customer for customer onboarding;
e. initiation of one or more projects between the first user, customer, and vendor over the platform comprising associating one or more customer projects on the platform;
f. Onboarding of the customer, vendor and third party entities by providing them access to the platform;
g. presentation by a presentation module of the dashboard view of one or more aspects of the project wherein the first user, customers, vendor and associated parties comprising all users are in network communication on the platform and the communication is selectively enabled by the first user between the customer and vendor depending on level of access provided by the user;
h. collaboration by a collaborating module of the user, customer, vendor, and third party entities on the platform;
i. initiation of the session on the shared space of the platform for real time interaction;
j. mapping of the information flow between the first user, customer, vendor, and third party entities, and integration of the communication tools of the user, customer, vendor and associated entities to the platform by the collaboration module over the network;
k. storing real-time and historic data of the interactive communication in the session related to the projects, related data and communication data of the user, customer, vendors and associated parties in the communication repository;
l. storing of the shared and other project related data of the user, customer, vendors and third parties post session in the database;
m. retrieving of the relevant data by the data retrieving module in the server as selected by the user customer and vendor and associated parties from the database;
n. and
   presentation by the presentation module on the dash board of the platform for implementation by the users, vendors and associated parties, wherein the platform is configured to share project data, integrate internal and external communication tools, work flow management tools and their respective communication on a single interface.

### EXAMPLE 6

A typical project implementation has multiple stakeholders working together to achieve the desired outcomes. The three prominent stakeholder types are:
1. Vendors (the one who provides the service)
2. Users (the one who receives the service)
3. Third party entities or partners (who assist the vendor with providing services to the user)

Organizations use shared workspaces/project management software to help manage and track the status of ongoing projects. These organizations use other software tools for various purposes including but not limited to communication (eg. Slack, MS Teams, Workplace), Service management (eg. Jira, ServiceNow, Helpdesks such as Freshdesk, Zendesk etc.) Most project management tools integrate with these tools. However, aforesaid integrations are enabled only for the vendor and this is considered industry-standard as of today.

The current project management tools provide no option for the users to integrate the tools they use (communication tools, service management tools and others). Users rely on emails and/or manual updates to stay on top of the projects with the vendors even though they have these tools in place to optimize their processes. The problem is more evident with partners or 3rd party entities who assist the vendors but lack the options to integrate their tools with the project management software which leads to accommodating manual processes and poor efficiency.

The present invention discloses a collaborative user facing project management system (100), which with its proprietary architecture allows each of the aforesaid stakeholders to connect their existing software tools to receive and manage events/updates/communications related to the projects.

Key components of the present invention.

### Hardware Components:

1. Cloud service provider
a. Power supply
b. Processor
c. Memory
d. Database
e. Messaging server
f. Process server
g. queuing server
h. scheduling server
i. I/O ports
j. I/O components
k. Routers
l. Presentation components

Software Components:
1. Browser platform
2. Vendor portal (where vendor access the projects from)
3. User portal (where user access the projects from)
4. Third party or partner portal (where partners access the projects from)

### Example 4

In view of the foregoing, one aspect of the current disclosure of the user facing collaborative platform according to various embodiments of the present invention, is that the platform connects for eg. Vendor 1—XCorp and their internal communication tools including but not limited to Slack, Jlra, Zendesk to get updates and workflows on the projects/implementations they do for their users.

For example Vendor 1 (XCorp) is doing a project for a user (user 1—S Ltd) with the help of two third party entities (Partner 1—Modert Inc and Partner 2—Pixel Inc).

Through the collaborative user facing project management system (100) of the present invention—Acme Corp can connect their internal tools with the current platform to get updates and workflows on all the projects they are delivering for all their users. Stark Ltd can connect their internal tools (Slack, Jira, Helpdesk etc.) through the platform to get updates and workflows on the projects that Acme Corp is delivering for them. Each of Modert, Inc and Pixel Inc can also connect their internal tools to get updates and workflows for the projects that Acme Corp has contracted them for.

Various modifications and structural changes may be made therein without departing from the spirit of the invention and within the scope and range of equivalents of the elements that will be claimed in the complete patent specification.

Advantages:
1. Provide a collaborative platform for managing user-facing projects that unifies vendors, users and third party entities.
2. Provide a platform for managing user-facing projects where stakeholders have clear accountability on their activities, visibility on the status of their activities and collaborate together over email and chat to complete the projects real-time.
3. Provide a system to connect each stakeholder's internal tools to integrate the project management software with their tools such as helpdesk tools, workplace communication tools, Sales management tools (CRM), support software, operations software (JIRA) etc. for seamless communication, collaboration, productivity.

We claim:

1. A system for collaborative user facing project management, comprising:
a service provider interface with a user facing project management platform;
a network;
one or more servers;
one or more user interfaces comprising vendor and associated parties;
wherein the user facing project management server comprises a communication collaboration module, processor, database or memory, a communication repository, data presentation module, data retrieving module, data notification module and computer readable instructions which when executed by the processor:
on boards users comprising vendors and associated third party entities, provides a communicable linkage by the communication collaboration module adapted to map information flow between service provider, vendors, and third parties associated with vendors, integrates the communication tools and work flow management tools of the users with the platform,
the communication repository is configured to dynamically update and store real-time data from one or more of the communication tools and the work flow management tools, integrated to the platform, database to store all the data the data retrieving module configured to retrieve relevant data from the memory and the communication repository based on the user input, and
the data presentation module adapted to provide conditional access to data mapped and identified by the communication collaboration module over the platform and display on the dashboard for exchange between vendor, and third parties that are integrated real-time to the platform, to access, manage and implement projects, project related communication and work flow management directly on the single user facing project management platform.

2. The system for collaborative user facing project management as claimed in claim 1, wherein the communication tools are selected from internal communication tools inbuilt in the server of service provider platform or external communication tools.

3. The system for collaborative user facing project management as claimed in claim 1, wherein the work flow management tools are selected from Jira, Slack, Zendesk, and the like.

4. The system for collaborative user facing project management as claimed in claim 1, wherein the communication tools comprises of MS teams, Google meet, electronic messaging accessible on any computer implementable device, comprising email, gmail, electronic text messaging and the like.

5. A method of implementation of a collaborative user facing project management system 100, comprising steps:
a. subscribing by a first user to a user facing service provider platform and accession by authentication;
b. connecting to the server over the network after authentication;
c. on-boarding a second user or customer onto the service provider platform;
d. initiation of a session on the interface for synchronous communication initially between the first user at the interface with the customer for customer onboarding;
e. initiation of one or more projects between the first user, customer, and vendor over the platform comprising associating one or more customer projects on the platform;
f. Onboarding of the customer, vendor and third party entities by providing them access to the platform;
g. presentation by a presentation module of the dashboard view of one or more aspects of the project wherein the first user, customers, vendor and associated parties comprising all users are in network communication on the platform and the communication is selectively enabled by the first user between the customer and vendor depending on level of access provided by the user;
h. collaboration by a collaborating module of the user, customer, vendor, and third party entities on the platform;
j. initiation of the session on the shared space of the platform for real time interaction;
mapping of the information flow between the first user, customer, vendor, and third party entities, and integration of the communication tools of the user, customer, vendor and associated entities to the platform by the collaboration module over the network;
k. storing real-time and historic data of the interactive communication in the session related to the projects, related data and communication data of the user, customer, vendors and associated parties in the communication repository;
l. storing of the shared and other project related data of the user, customer, vendors and third parties post session in the database;
m. retrieving of the relevant data by the data retrieving module in the server as selected by the user customer and vendor and associated parties from the database, and
wherein the platform is configured to collaborate and share centralized communication shared between the parties collaborating on the platform, collaborate one or more teams workflow management and integrate the data on the user facing project management platform from external and internal communication and workflow management tools.

6. The method of implementation or execution of a collaborative user facing project management system as claimed in claim 5, wherein data stored in the memory comprises project configuration and progress data, and communication repository comprises of communication exchange data between vendors customers and third parties from internal and external communication tools.

7. The method of implementation or execution of a collaborative user facing project management system as claimed in claim 5, wherein project progress data is selected from, but not limited to status, stage of progress, meeting of timelines, and the like.

8. The method of implementation or execution of a collaborative user facing project management system as claimed in claim 5, wherein the platform comprises a share space in the server for real-time data sharing between collaborating parties.

9. The method of implementation or execution of a collaborative user facing project management system as claimed in claim 5, wherein the user interface comprises computer implementable device comprising personal computer, laptop, hand held computer, personal digital device, electronic tablet, cellular phone, any smart of intelligent electronic device and the like.

10. The method of implementation or execution of a collaborative user facing project management system as claimed in claim 5, wherein the project view can be stored as a template and replicated for future use for other projects.

11. The method of implementation or execution of a collaborative user facing project management system as claimed in claim 5, wherein data module is configured to update the database and extract the data based on the user selection of data preferences on the platform.

12. The method of implementation or execution of a collaborative user facing project management system as claimed in claim 5, wherein the dashboard view of the platform is configured to provide a consolidated view of all the ongoing projects in a single window simultaneously.

13. The method of implementation or execution of a collaborative user facing project management system as claimed in claim 5, wherein the dashboard of the platform is configured to be accessed on any computer implementable device.

14. The method of implementation or execution of a collaborative user facing project management system as claimed in claim 5, wherein the data is exchanged between the vendor, and any third party associated to the vendor on the webpage or the portal by dynamic transfer using the dynamic communication tools.

15. The method of implementation or execution of a collaborative user facing project management system as claimed in claim 5, wherein communication tools are inbuilt tools in the server or external communication tools selected from one or more of Jira, Slack, Zendesk, MS teams, Google meet and the like that are integrated into the platform by the communication collaboration tool.
